(19) United States
(12) Patent Application Publication
(10) Pub. No.: US 2006/0226140 A1
(43) Pub. Date: Oct. 12, 2006

(54) Heated tray

(75) Inventors: Charlie Rosenberg, Miami, FL (US); Norman Brooks, Miami, FL (US)

Correspondence Address: ROBERT M. SCHWARTZ, P.A., P.O. BOX 221470, HOLLYWOOD, FL, 33022, US

(73) Assignee: Mr. Sake, LLC

(21) Appl. No.: 11/339,433

(22) Filed: Jan. 25, 2006

Related U.S. Application Data
(60) Provisional application No. 60/646,678, filed on Jan. 25, 2005.

(51) Int. Cl. F27D 11/00

(52) U.S. Cl. 219/438; 219/441

(57) ABSTRACT

The present invention relates to a food warming apparatus, particularly to a tray, containing the heating elements, and a base that supplies electrical energy to the heating elements that work in conjunction with an accompanying beverage container for warming alcoholic beverages, such as Saké. When at least one Tokkuri (a flask-shaped vessel) containing Saké is placed on the apparatus, the Saké is heated to a desired consumption temperature less than 160 degrees Fahrenheit, with 131 degrees Fahrenheit preferred. Features such as a removable tray allowing portability of the tray and the warm Tokkuri, and presence switches that detect placement of the Tokkuri on the tray are described.

### TECHNICAL FIELD OF THE INVENTION

The present invention relates to a food warming apparatus, particularly to a tray, a base, and accompanying beverage container designed for warming alcoholic beverages, such as Saké.

### BACKGROUND OF THE INVENTION

Saké is a beverage fermented from rice containing approximately 15-17% alcohol by volume. Saké, is generally transparent and not aged and will last about one year without breaking down if kept in a cold, dark location. It also does not contain Sulfites, and has five (5) times more amino acid than wine. Saké is especially popular while eating seafood, and is served warm or cold. Warming Saké enhances the tasting experience and the effect of the alcohol for the consumer.

There are conceivably many ways of warming Saké, however it is not advisable to use boiling water nor a microwave oven for such warming.

The invention described herein presents an apparatus for quickly warming Saké to a desired consumption temperature less than 160 degrees Fahrenheit, with 131 degrees Fahrenheit preferred.

### SUMMARY OF THE INVENTION

The present invention presents a warming tray apparatus upon which at least one Tokkuri (a flask-shaped vessel) containing Saké is heated. At least one switch-activated electrical heating element resides within a thermally conductive tray. Said tray is designed to be precisely placed on a base housing so that electrical contacts positioned within said base align with electrical receptacles of individual heating elements within said tray, whereby electrical power is supplied from said base to said individual heating elements. Electrical power is supplied to said base through a power cord connected between said base and an external power source. Temperature regulation is performed by at least one thermostat.

The tray is designed to be removed from said base following heating of the Saké to the desired temperature, allowing convenient movement of the Tokkuri from the location of heating to the location of Saké consumption.

### BRIEF DESCRIPTION OF THE DRAWINGS

FIG. 1 is an illustration of one embodiment of the present invention. It outlines the major components of the Saké heating system. Also shown are optional on-off presence switches that respond to the presence of the Tokkuri and regulate power delivery to the heating elements within the tray. A block diagram indicates operation of the apparatus.

FIG. 2 is a drawing indicating major electrical and mechanical components of the invention.

FIG. 3 is a mechanical drawing indicating components of the Tokkuri designed for heating Saké.

FIG. 4 is a mechanical drawing of a second embodiment of the Tokkuri designed for heating Saké.

FIG. 5 is a diagram showing the electrical heating element and thermostat for placement within the removable tray.

FIG. 6 is a mechanical drawing of the aluminum pan in which the heating element is placed.

FIG. 7 is a mechanical drawing of the insulator ring.

FIG. 8 shows a cross-section of two embodiments of the ceramic portion of the Tokkuri in contact with the stainless steel portion.

### DETAILED DESCRIPTION OF THE EMBODIMENTS

The present invention details a warming tray apparatus for heating Saké in at least one Tokkuri (a flask-shaped vessel). A first embodiment outlines an apparatus allowing heating of a single Tokkuri, however additional embodiments can permit placement of multiple Tokkuri vessels onto a warming tray housing multiple heating elements.

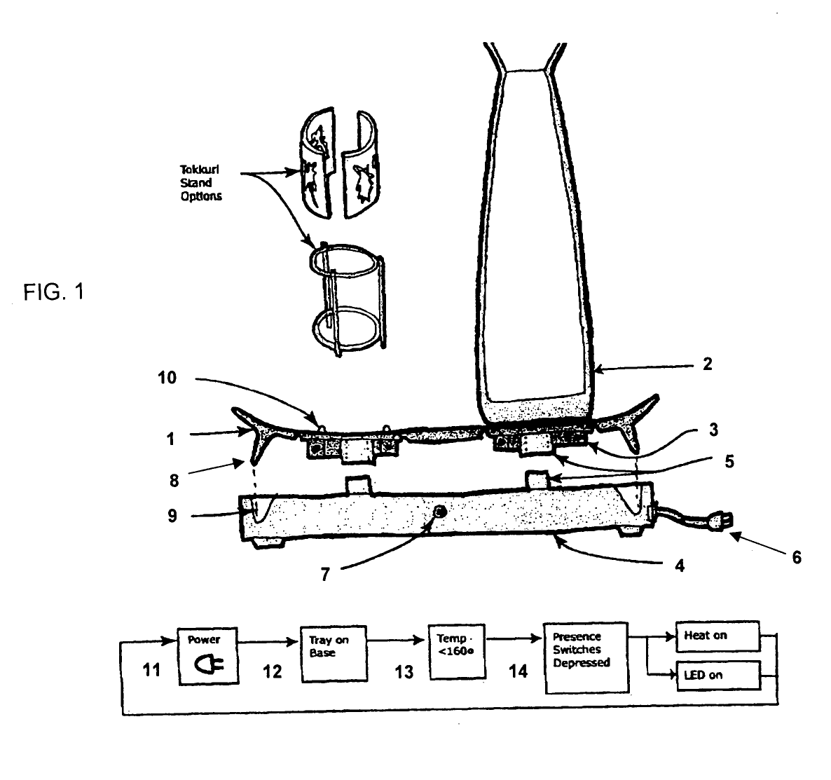

FIG. 1 is an illustration of an embodiment of the present invention with two heating elements. It outlines the major components of the system, including a heating tray 1, that carries the Tokkuri 2, at least one heating element within the tray 3, a base 4 that supplies electrical current to the heating elements within the tray via electrical connections 5 between the base and the tray. Electricity is supplied to the base through a power cord 6 between the base and an external power source, and current flow to the heating element is indicated by activation of an LED 7. Precise alignment of the heating tray with the base is performed by placement of feet 8 integral to the tray into cutouts 9 in the base. This placement permits electrical contacts within the tray to align with electrical contacts within the base, allowing delivery of electrical energy. Optionally, on-off presence switches 10, located on the tray can toggle current flow within the circuit when the Tokkuri is placed on the tray. An electo-mechanical switch that is activated by the weight of a Tokkuri placed on the tray is one example of such a switch. A Hall-effect switch that responds to magnetic force is an example of a second type of an on-off switch that can be used in this design. These switches permit or inhibit electrical energy delivery to heating elements within the tray.

FIG. 1 also shows a block diagram outlining operation of one embodiment of the apparatus. When an external power source is connected to the base, box 11, and the tray is placed on the base, box 12, and the temperature of the tray is less than 160 degrees Fahrenheit, box 13, and the presence switches are depressed, box 14, e.g. due to a Tokkuri placed on the tray, current is permitted to flow to the heating element and the power flow indicator LED 7 turns on. As indicated, these logic conditions form a continuous loop that is applied by circuitry within the apparatus.

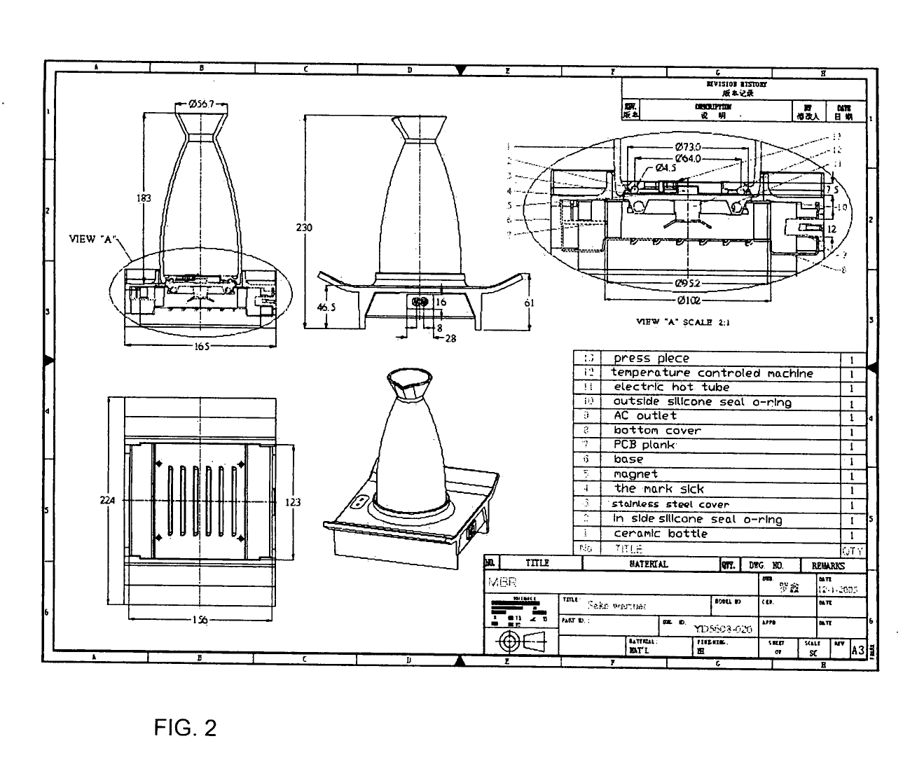

FIG. 2 offers a detailed view of a single Tokkuri tray apparatus. Of particular note in this diagram is the “temperature controlled machine” that acts as a thermostatic switch that regulates energy delivery to the electric heating element. Also shown are several seals that function to prevent escape of liquid from the Tokkuri.

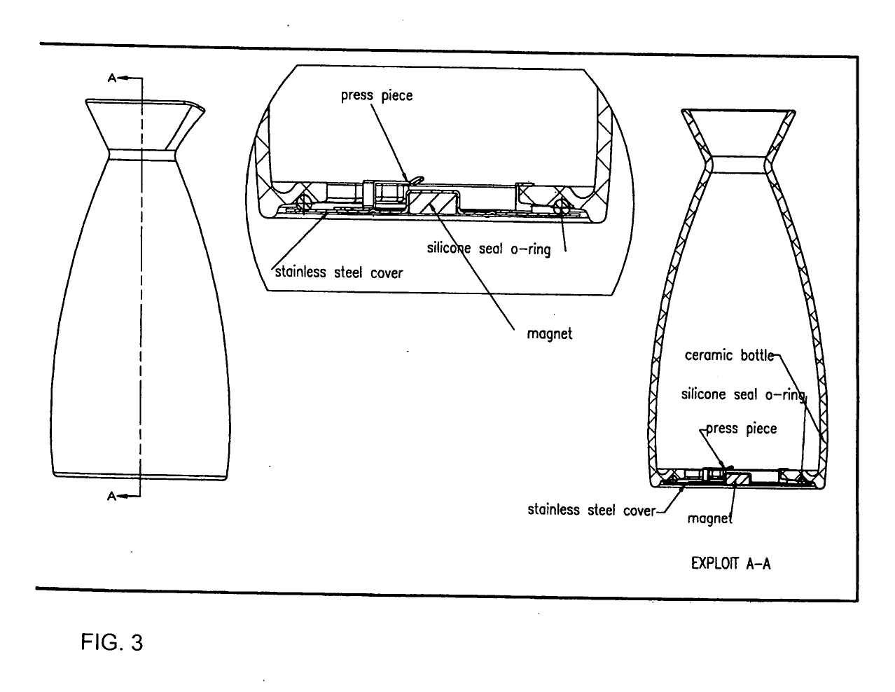

A cross-sectional diagram of the Tokkuri is shown in FIG. 3. The upper portion of the Tokkuri is constructed from ceramic, while the lower portion of the Tokkuri in contact with the heating plate when placed on the tray, is constructed from stainless steel. A silicone seal O-ring is shown that functions to prevent loss of fluid between the ceramic portion of the Tokkuri and the metal portion of the Tokkuri.

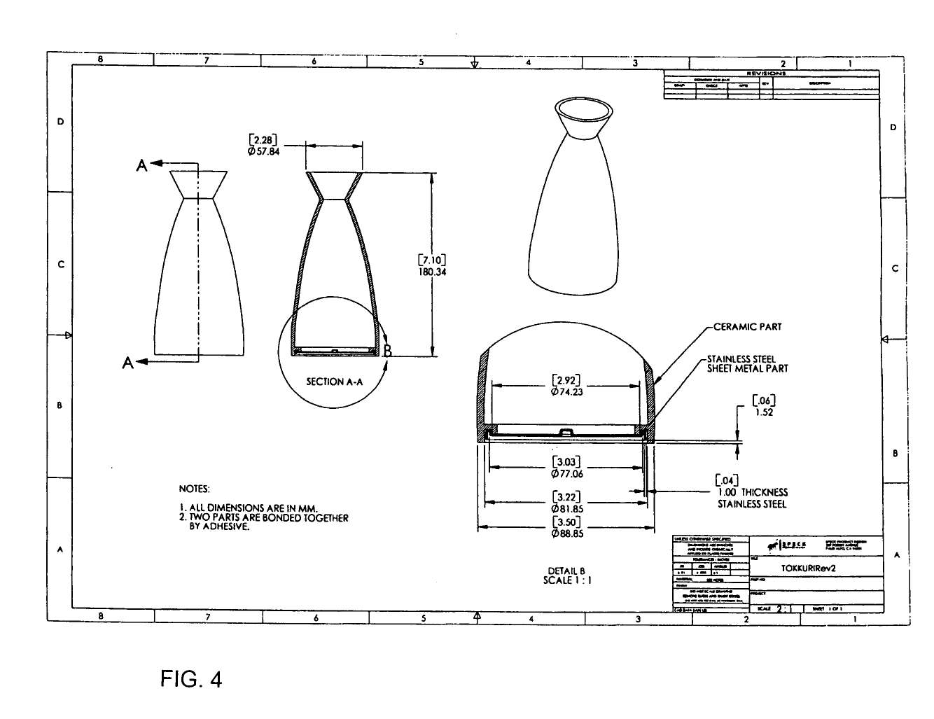

A second embodiment of the Tokkuri design is shown in FIG. 4. In this design, a stainless steel bottom is bonded to the ceramic upper portion of the Tokkuri using an adhesive.

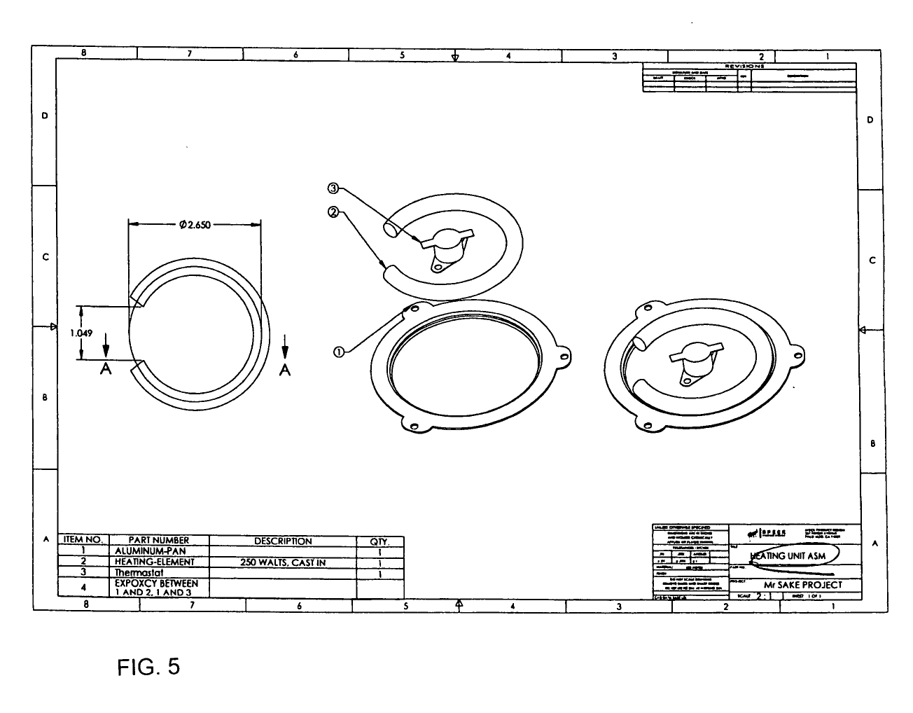

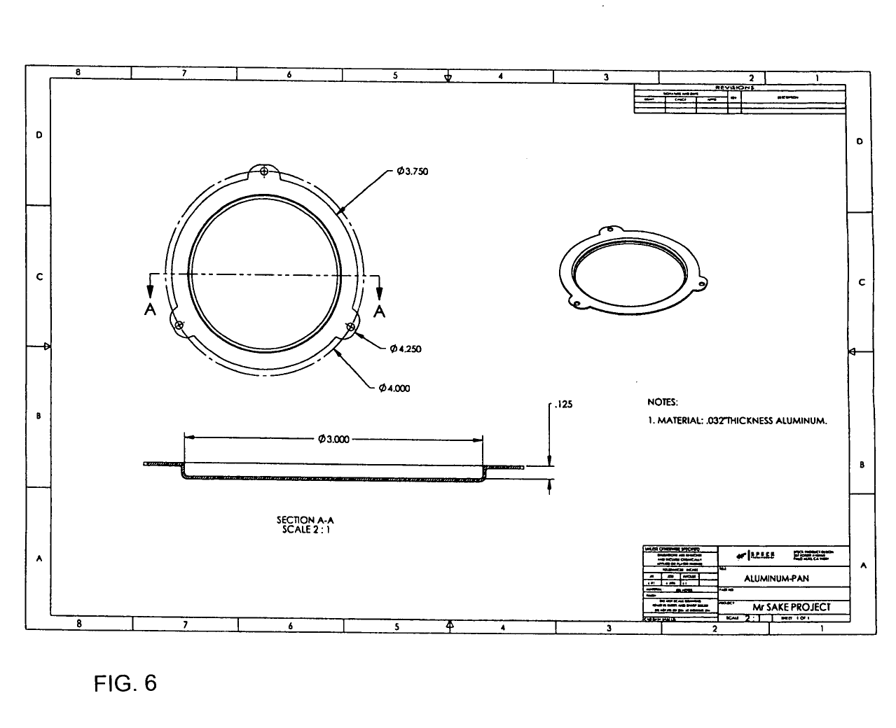

Details of the electrical heating element assembly is shown in FIG. 5. A heating element and thermostat are placed within a metal (e.g. aluminum) pan. The thermostat regulates current flow to the heating element in response to temperature. Dimensional details of the aluminum pan are shown in FIG. 6.

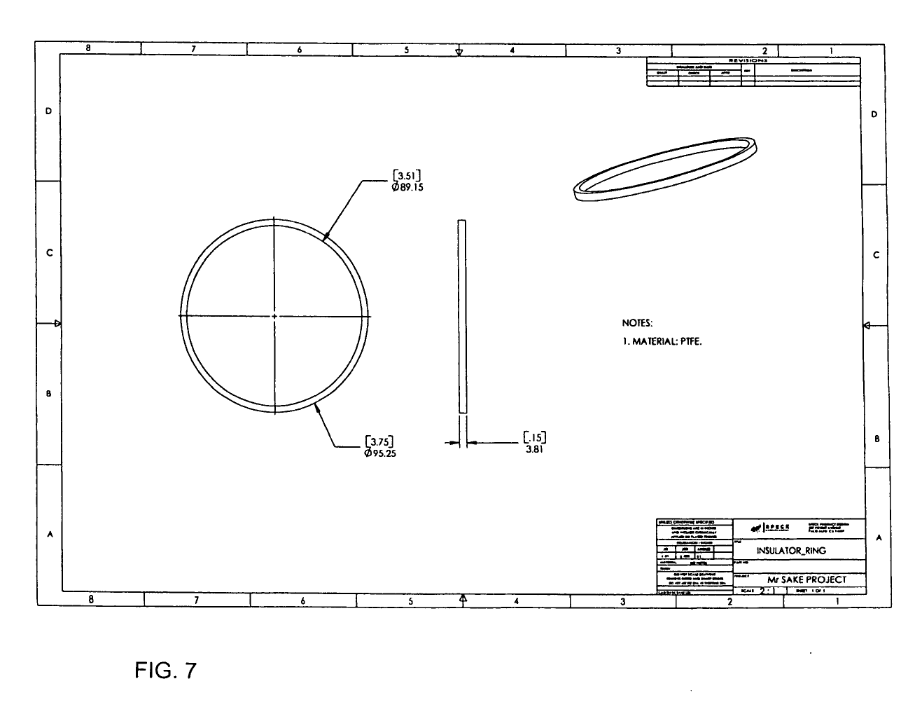

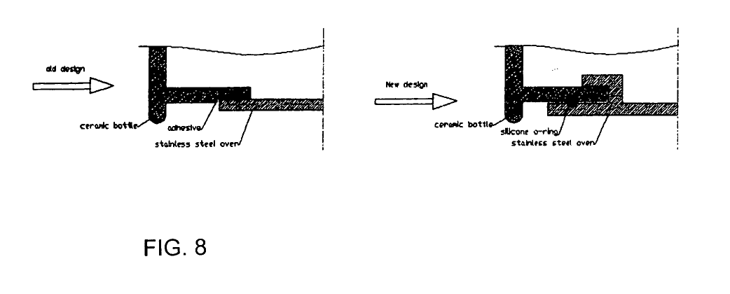

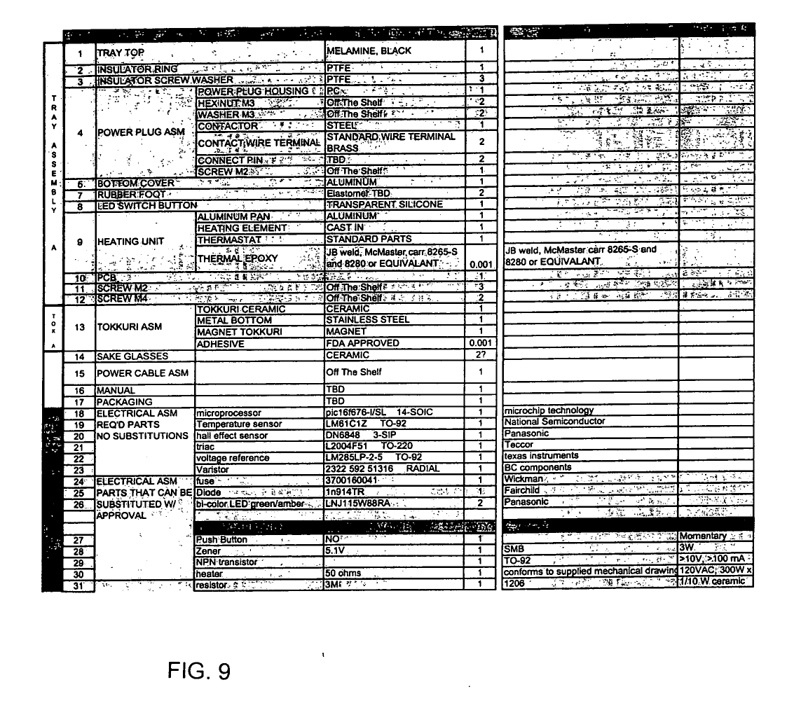

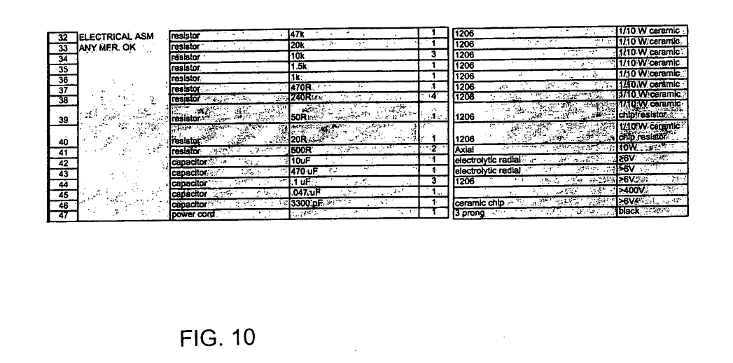

FIG. 7 is a mechanical drawing of the insulator ring detailing the dimensions of said ring. Two embodiments of the fitting between the ceramic Tokkuri and a stainless steel plate are shown in FIG. 8. In the first embodiment, an adhesive is used between the ceramic portion of the Tokkuri and the stainless steel portion, while the second embodiment uses a silicon O-ring between the two structures.

A detailed parts list for a single heating element design for the present invention is shown in FIGS. 9 and 10. Tray designs using multiple heating elements can be realized by using a multiple of parts from the list shown in FIGS. 9 and 10, and adapting the tray and base dimensions accordingly.

Although only a few exemplary embodiments of the present invention have been described in detail above, those skilled in the art will readily appreciate that numerous modifications are possible to the exemplary embodiments without materially departing from the novel teachings and advantages of this invention. Accordingly, all such modifications are intended to be included within the scope of this invention.

What is claimed is:

1) An apparatus comprising:
a tray with at least one electrical heating element for warming a vessel containing a food product placed therein;
a base with at least one electrical connection permitting delivery of electrical energy between an external power source and said heating element within said tray;
a temperature regulation circuit controlling electrical power delivery to said at least one electrical heating element;
wherein said tray is removably placed upon said base and said vessel is removably placed upon said tray allowing heating of said food product.
